(19) United States
(12) Patent Application Publication
(10) Pub. No.: US 2023/0317039 A1
(43) Pub. Date: Oct. 5, 2023

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventor: Tsutomu YAMAGUCHI, Hamamatsu-shi (JP)

(21) Appl. No.: 18/188,310

(22) Filed: Mar. 22, 2023

(30) Foreign Application Priority Data
Mar. 30, 2022 (JP) 2022-056839
Mar. 30, 2022 (JP) 2022-056843

(51) Int. Cl. G10H 1/34

(52) U.S. Cl. CPC G10H 1/346; G10H 2220/265; G10H 2220/221

(57) ABSTRACT

A keyboard device for a keyboard instrument includes a keyboard chassis, keys disposed on the keyboard chassis, and a key support mechanism which is provided so as to support the keys from below, and causes, upon depression of a key, the depressed key to operate such that the key pivotally moves about a virtual pivot located rearward of a rear end of the key. The keyboard chassis includes a key stopper with which a rear end of an associated key moves into contact from below when the key returns to its original position before the key depression. The key includes a contact surface for contacting the key stopper in a key-released state, and a protrusion formed to protrude upward from the contact surface. At least one of the key stopper and the protrusion is disposed in plurality along a longitudinal direction of the key.

### BACKGROUND OF THE INVENTION

### Field of the Invention

The present invention relates to a keyboard device for a keyboard instrument, which is applied to a keyboard instrument, such as an electronic piano, and in which a depressed one of keys operates such that it pivotally moves about a virtual pivot located rearward of a rear end of the key.

### Description of the Related Art

Conventionally, as this type of a keyboard device, there has been known, for example, one disclosed in Japanese Laid-Open Patent Publication (Kokai) No. H10-340079. In this keyboard device, keys extending in a front-rear direction are disposed on an upper portion of a keyboard chassis. Each key has a front end thereof provided with a stopper portion that extends downward and has a lower end bent forward. Further, a rear end of the key is supported by a key support member, and with this, the key is configured to pivotally move downward about a virtual pivot located rearward of the rear end of the key during key depression. Furthermore, a hammer arm is pivotally movably provided below the key such that the hammer arm pivotally moves along with the key depression.

In the keyboard device constructed as above, during key depression, when one of the keys is depressed, the key nearly parallelly moves downward. In this case, the hammer arm below the key is pivotally moved in a predetermined direction by the key being depressed. Further, when the depression of the key is released, the hammer arm pivotally moves in a direction opposite to the above-mentioned direction, and the key pushed upward along with this pivotal movement of the hammer arm returns to its original position where it was before the key depression. In this case, the stopper portion provided at a lower portion of the front end of the key moves into contact with an upper limit stopper provided on the keyboard chassis from below, which blocks further upward movement of the key.

Further, as this type of a keyboard device, there has been known, for example, one disclosed in Japanese Laid-Open Patent Publication (Kokai) No. 2014-10374. In this keyboard device, hammers are pivotally movably provided on a key-by-key basis below keys extending in a front-rear direction. In a key-released state, each hammer extends in the front-rear direction in a state inclined downward toward the rear such that a rear end thereof contacts a stopper from above. This stopper is formed of a stopper rail horizontally extending in a left-right direction, and a cushioning material formed on an upper surface of the stopper rail and having a predetermined rectangular shape in transverse cross-section over the entire longitudinal length thereof.

In the keyboard device including the stopper described above, when one of the keys is depressed, a hammer associated with the key is pivotally moved in a predetermined direction, and a rear end of the hammer moves above the stopper. Then, when the key is released, the hammer is pivotally moved in a direction opposite to the above-mentioned direction, and the rear end of the hammer moves into contact with the stopper from above.

In the keyboard device disclosed in Japanese Laid-Open Patent Publication (Kokai) No. H10-340079, in the case where the depressed key returns to its original position, the key is vigorously pushed up by the hammer arm pivotally moving, and consequently the stopper portion on the front end of the key sometimes hits hard against the upper limit stopper. When the stopper portion of the key thus hits hard against the upper limit stopper, noise is generated. Of course, by using a relatively soft cushion as the upper limit stopper, it is possible to suppress generation of noise. In this case, however, upper limit positions of a large number of keys arranged side by side in a left-right direction sometimes fail to be aligned to each other. In addition, the hammer arm, upon returning to its original position, is liable to bounce, and accordingly, there is a possibility that the key having returned to its original position does not immediately come to a standstill or even a possibility that mechanical noise is generated from portions of the key and the hammer arm.

Further, since the stopper disclosed in Japanese Laid-Open Patent Publication (Kokai) No. 2014-10374 is shared by a white key-associated hammer and a black key-associated hammer, the following problem occurs: In a case where the white key-associated hammer is heavier than the black key-associated hammer, when the white key-associated hammer moves into contact with the cushioning material, the white key-associated hammer sinks deeper than the black key-associated hammer, and sometimes bounds more than the black key-associated hammer before the white key-associated hammer completely stops. In this case, touch feeling is different between a white key and a black key, and it is difficult to optimally adjust both the touch feeling of the white key and that of the black key.

Further, in a case where the same hammers are used as the white key-associated hammer and the black key-associated hammer, when a posture in the key released state or a height with respect to the stopper is different between the white key-associated hammer and the black key-associated hammer, it is necessary to adjust the shape of weights attached to the hammers or adjust the height of a portion of the cushioning material, contacted by the hammer, which increases manufacturing costs.

### SUMMARY OF THE INVENTION

It is a first object of the present invention to provide a keyboard device for a keyboard instrument, which, when a depressed key returns to its original position where it was before key depression, is capable of suppressing generation of noise and promptly bringing the key to a standstill.

It is a second object of the present invention to provide a keyboard device for a keyboard instrument, which is capable of adjusting heights or amounts at which hammers associated with respective keys move into contact with a stopper, by a relatively simple construction, thereby obtaining excellent touch feeling of the keys.

To attain the above first object, in a first aspect of the present invention, there is provided a keyboard device for a keyboard instrument, including a keyboard chassis, a key extending a predetermined length in a front-rear direction and disposed on the keyboard chassis, and a key support mechanism engaged with the keyboard chassis and provided so as to support the key from below, the key support mechanism causing, upon depression of the key, the depressed key to operate such that the key pivotally moves about a virtual pivot located rearward of a rear end of the key, wherein the keyboard chassis includes a key stopper with which a rear end of the key moves into contact from below when the key returns to its original position where the key was before the key depression, wherein the key includes a contact surface which contacts the key stopper, when in a key-released state, and a protrusion formed to protrude upward from the contact surface, and wherein at least one of the key stopper and the protrusion is disposed in plurality along a longitudinal direction of the key.

With the construction of the first aspect of the present invention, when the key supported by the key support mechanism from below is depressed, the key pivotally moves about the virtual pivot located rearward of the rear end of the key. In this case, since the depressed key moves downward as a whole, the front end and the rear end of the key are located below their original positions before the key depression. When the key having been depressed is released, thereby returning to its original position where it was before the key depression, the rear end of the key moves into contact with the key stopper provided on the keyboard chassis from below. In this case, after the protrusion provided at the rear end of the key moves into contact with the key stopper, the contact surface formed on the rear end of the key moves into contact with the key stopper. As described above, since the protrusion contacts the key stopper before the contact surface contacts the key stopper, kinetic energy of the rising rear end of the key is progressively reduced, whereby it is possible to promptly bring to a standstill the key having returned to its original position where it was before the key depression while suppressing generation of noise. Further, at least one of the key stopper provided on the keyboard chassis and the protrusion provided at the rear end of the key is disposed in plurality along a longitudinal direction of the key, and hence compared with a case where a single key stopper and a single protrusion are provided, it is possible to enhance an effect of suppressing generation of noise and an effect of bringing the key to a standstill.

Preferably, the keyboard chassis includes a front-side stopper and a rear-side stopper disposed forward and rearward of each other, as the key stopper, the key including one protrusion as the protrusion which contacts one key stopper of the front-side stopper and the rear-side stopper, and the one key stopper is made of an elastic material having a lower resilience than the other key stopper of the front-side stopper and the rear-side stopper.

With the construction of this preferred embodiment, the keyboard chassis is provided with the front-side stopper and the rear-side stopper as the key stopper, and the key is provided with a single protrusion for moving into contact with one key stopper of the front-side stopper and the rear-side stopper. When the rear end of the key moves upward to thereby contact the key stopper from below, first, the protrusion of the key contacts the one key stopper. Then, the rear end of the key moves further upward, so that the contact surface of the key contacts the front-side stopper and the rear-side stopper from below. As described above, since the protrusion of the key contacts the one key stopper before the contact surface of the key contacts the front-side stopper and the rear-side stopper, it is possible to progressively reduce the kinetic energy of the rising rear end of the key. Further, since the one key stopper, which contacts the protrusion of the key, is made of an elastic material having a lower resilience than the other key stopper of the front-side stopper and the rear-side stopper, it is possible to effectively suppress generation of noise when the protrusion of the key contacts the one key stopper.

Preferably, the keyboard chassis has one key stopper as the key stopper, the key including a front-side protrusion and a rear-side protrusion arranged forward and rearward of each other, as the protrusion, and one protrusion of the front-side protrusion and the rear-side protrusion is formed such that the one protrusion has an upper surface area smaller than that of the other protrusion of the front-side protrusion and the rear-side protrusion, and protrudes upward of the other protrusion.

With the construction of this preferred embodiment, the keyboard chassis is provided with a single key stopper, whereas the rear end of the key is provided with the front-side protrusion and the rear-side protrusion. The one protrusion of the front-side protrusion and the rear-side protrusion has an upper surface area smaller than that of the other protrusion of the front-side protrusion and the rear-side protrusion, and protrudes upward of the other protrusion. When the rear end of the key moves upward to thereby contact the key stopper from below, first, the one protrusion contacts the key stopper. Then, the rear end of the key moves further upward, so that the other protrusion contacts the key stopper. Then, the rear end of the key moves further upward, so that the contact surface contacts the key stopper. As described above, when the rear end of the key contacts the key stopper, the rear end contacts the key stopper sequentially staring with the protrusion having a smaller upper surface area, so that it is possible to smoothly reduce the kinetic energy of the rising rear end of the key while effectively suppressing generation of noise when the rear end of the key moves into contact with the key stopper.

In a second aspect of the present invention, there is provided a keyboard device for a keyboard instrument, including a keyboard chassis, a key extending a predetermined length in a front-rear direction and disposed on the keyboard chassis, and a key support mechanism engaged with the keyboard chassis and provided so as to support the key from below, the key support mechanism causing, upon depression of the key, the depressed key to operate such that the key pivotally moves about a virtual pivot located rearward of a rear end of the key, wherein the keyboard chassis includes a key stopper with which a rear end of the key moves into contact from below when the key returns to its original position where the key was before the key depression, wherein the key includes a contact surface for moving into contact with the key stopper in a key-released state, and a protrusion formed to protrude upward from the contact surface, and wherein the key stopper has a lower surface formed in a state inclined in the front-rear direction.

With the construction of the second aspect of the present invention, when the key supported by the key support mechanism from below is depressed, the key pivotally moves about the virtual pivot located rearward of the rear end of the key. Then, when the key having been depressed is released, thereby returning to its original position where it was before the key depression, the rear end of the key moves into contact with the key stopper provided on the keyboard chassis from below. Further, the rear end of the key is provided with the contact surface for moving into contact with the key stopper in the key-released state, and the protrusion protruding upward from the contact surface. Further, the lower surface of the key stopper is formed into the state inclined in the front-rear direction.

When the rear end of the key, constructed as described above, moves upward and contacts the key stopper from below, the protrusion which is smaller in surface area contacts the key stopper before the contact surface of the key contacts the key stopper, whereby the kinetic energy of the rising rear end of the key is progressively reduced, and generation of bouncing motion of the rear end of the key and noise can be effectively suppressed when the contact surface of the key contacts the key stopper. Further, since the lower surface of the key stopper is formed into the state inclined in the front-rear direction, it is possible to cause the rear end of the key to contact the key stopper such that an area of contact between the rear end of the key and the key stopper is progressively increased. With this, compared with a case where the area of contact between the rear end of the key and the key stopper is large from the beginning, it is possible to suppress generation of noise when the contact surface of the key contacts the key stopper.

To attain the above second object, in a third aspect of the present invention, there is provided a keyboard device for a keyboard instrument, including a keyboard chassis, a plurality of keys each extending in a front-rear direction and arranged side by side in a left-right direction on the keyboard chassis, the plurality of keys being formed by white keys and black keys, a plurality of hammers extending in the front-rear direction and provided in association with the plurality of keys, respectively, the hammers being pivotally supported, below the keys, on the keyboard chassis, each via a hammer support shaft, and arranged side by side in the left-right direction, for each being vertically pivotally moved in a manner interlocked with depression of an associated one of the keys, a stopper rail formed into a plate shape extending in the left-right direction and disposed below the keyboard chassis, and a cushion extending in the left-right direction and having a uniform shape in transverse cross-section over the entire longitudinal length of the cushion, the cushion being mounted in a state placed on the stopper rail and being disposed such that predetermined portions of the plurality of hammers are placed on or opposed to the cushion in a key-released state, the cushion being contacted by the predetermined portions of the hammers from above when the hammers having been pivotally moved upward in accordance with depression of the key return to their original positions after release of the key depressed, wherein the stopper rail has first key type-associated portions, which are portions below the cushion, for being contacted by associated ones of the hammers associated with a first key type as one of key types of the white keys and the black keys, the first key type-associated portions being formed such that the first key type-associated portions are cut out or lower by a predetermined height with respect to second key type-associated portions, which are portions below the cushion, for being contacted by associated ones of the hammers associated with a second key type as the other of the key types of the white keys and the black keys.

With the construction of the third aspect of the present invention, the stopper rail having the plate shape extending in the left-right direction is disposed below the keyboard chassis. On this stopper rail, the cushion having the uniform shape in transverse cross-section over the entire longitudinal length thereof is mounted in the state placed on the stopper rail. The cushion is contacted from above by the predetermined portions of the hammers associated with the white keys and the black keys, respectively. Further, the stopper rail has the first key type-associated portions, which are portions below the cushion, for being contacted by the associated ones of the hammers associated with the first key type as one of the key types of the white keys and the black keys. The first key type-associated portions are formed such that they are cut out or lower by a predetermined height with respect to the second key type-associated portions, which are portions below the cushion, for being contacted by the associated ones of the hammers associated with the second key type as the other the key types of the white keys and the black keys. With this, although the cushion mounted on the stopper rail has the uniform shape in transverse cross-section, the portions of the cushion associated with the first key type-associated portions of the stopper rail have lower upper surfaces or larger amounts of contact with the hammers than the portions of the cushion associated with the second key type-associated portions of the stopper rail. As described above, by employing a relatively simple construction in which the first key type-associated portions of the stopper rail are cut out or made lower than the second key type-associated portions, it is possible to adjust heights and amounts of contact with the first arms associated with the respective keys, whereby it is possible to obtain excellent touch feeling of the keys.

Preferably, the first key type-associated portions are configured to be lower by the predetermined height than the second key type-associated portions, and in the stopper rail, upper surfaces of the first key type-associated portions being formed such that the upper surfaces are inclined forward and downward as the upper surfaces extend outward in the front-rear direction.

With the construction of this preferred embodiment, in the stopper rail, the first key type-associated portions are formed to be lower by the predetermined height than the second key type-associated portions, and the upper surfaces of the first key type-associated portions are formed such that the upper surfaces are inclined forward and downward as the upper surfaces extend outward in the front-rear direction. Therefore, it is possible to relatively easily and stably mount the cushion having the uniform shape in transverse cross-section mount on the stopper rail by bonding the cushion not only to upper surfaces of the second key type-associated portions but also to upper surfaces of the first key type-associated portions. Further, since the upper surfaces of the first key type-associated portions of the stopper rail are formed such that the upper surfaces are inclined forward and downward as the upper surfaces extend outward in the front-rear direction, it is possible to relatively easily and stably work on the first key type-associated portions of the stopper rail.

Preferably, the first key type is a black key, and the second key type is a white key.

With the construction of this preferred embodiment, by setting the first key type as a black key and the second key type as a white key, the black key-associated portions, which are portions of the stopper rai below the cushion, for being contacted by the black key-associated hammers, are formed such that the black key-associated portions are cut out or lower by the predetermined height with respect to the white key-associated portions, which are portions of the stopper rail below the cushion, for being contacted by the white key-associated hammers. With this, for example, by forming the stopper rail and the cushion such that they optimally match the white key-associated hammers, and then vertically adjusting portions of the cushion associated with the black key-associated portions of the stopper rail, it is possible to obtain excellent touch feelings of both the white keys and the black keys.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device shown in FIG. 1B and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIG. 7A and 7B are views useful in explaining operation of the black key in the keyboard device, in which FIG. 7A shows a key-released state and FIG. 7B shows a key-depressed state;

FIGS. 8A and 8B are diagrams showing a rear end of a key of the keyboard device and component parts therearound on an enlarged scale, which are useful in explaining an essential part of a first embodiment of the present invention, in which FIG. 8A shows a key-released state and FIG. 8B shows a key-depressed state;

FIGS. 9A and 9B each show an appearance of the white key, in which FIG. 9A is a perspective view and FIG. 9B is a right side view;

FIGS. 10A to 10C are views useful in explaining movement of the rear end of the key as the rear end moves into contact with key stoppers from below;

FIGS. 11A and 11B are diagrams showing a rear end of a key of the keyboard device and component parts therearound on an enlarged scale, which are useful in explaining an essential part of a second embodiment of the present invention, in which FIG. 11A shows a key-released state and FIG. 11B shows a key-depressed state;

FIGS. 12A to 12D are views useful in explaining movement of the rear end of the key as the rear end moves into contact with a key stopper from below;

FIGS. 13A to 13D are views useful in explaining a variety of variations of a protrusion formed at the rear end of the key;

FIG. 14 is a view useful in explaining a variation of a key stopper with which the rear end of the key moves into contact;

FIGS. 15A and 15B are diagrams useful in explaining an essential part of a third embodiment of the present invention, in which FIG. 15A is a perspective view of the keyboard device, as viewed from below, and FIG. 15B is a perspective view of front-side and rear-side first arm stoppers, as viewed from above;

FIG. 16 is a perspective view of the front-side and rear-side first arm stoppers in a state in which stopper rails are separated from cushions associated therewith; and

FIG. 17 is a perspective view of a variation of the stopper rail of the rear-side first arm stopper.

### DETAILED DESCRIPTION OF PREFERRED EMBODIMENTS

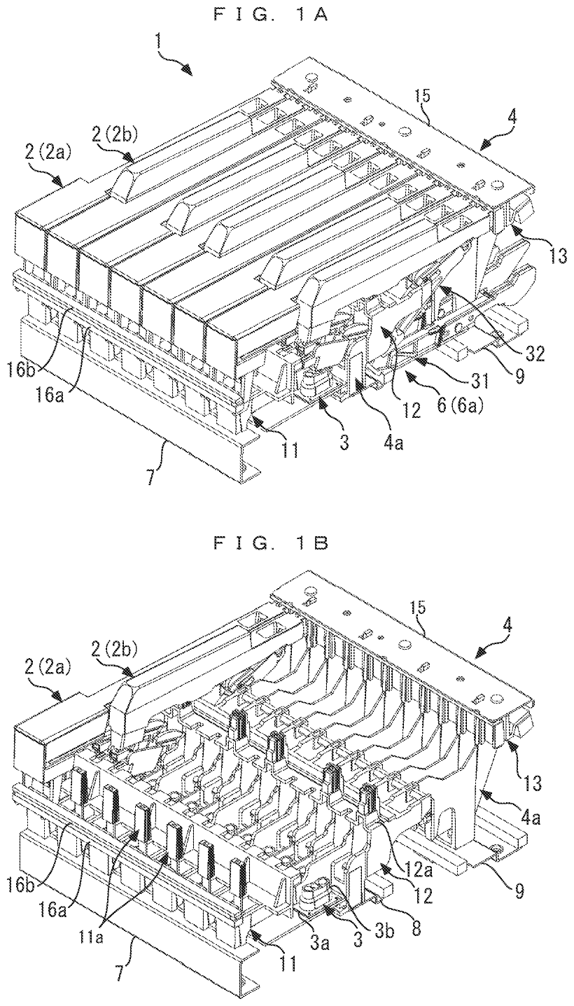

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of essential parts of first to third embodiments of the present invention.

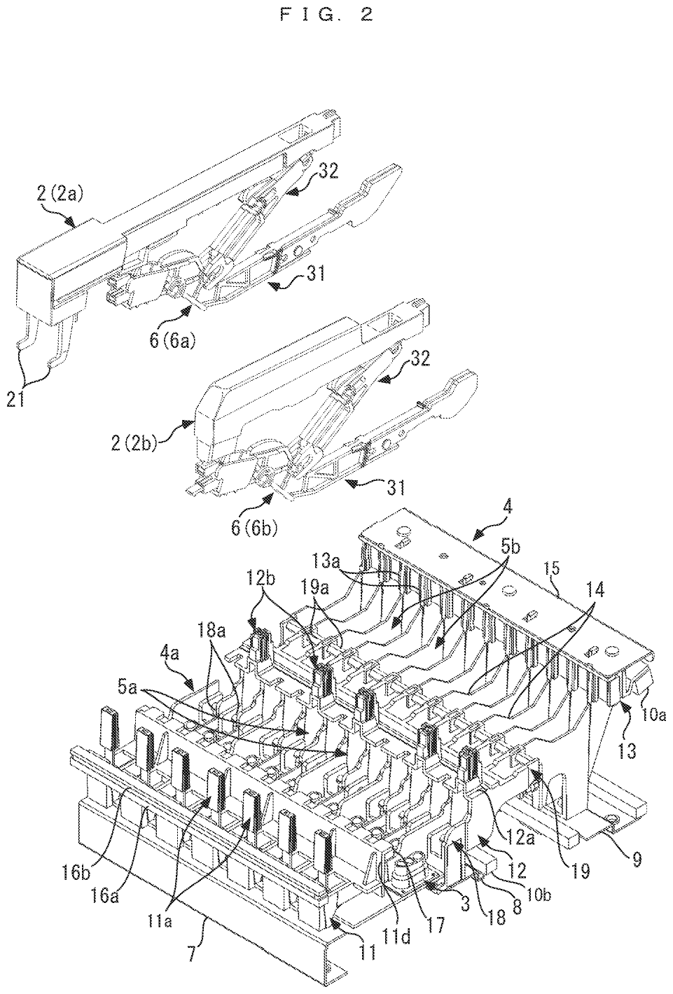

FIG. 1B shows a state of the keyboard device 1 shown in FIG. 1A, in which keys 2 other than a white key 2a and a black key 2b at the left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and arranged in a state arranged side by side in a left-right direction, the plurality of key support mechanisms 6 each pivotally mounted on the keyboard chassis 4, for supporting an associated one of the keys 2 from below, and key switches 3 each for detecting key depression information of an associated one of the keys 2.

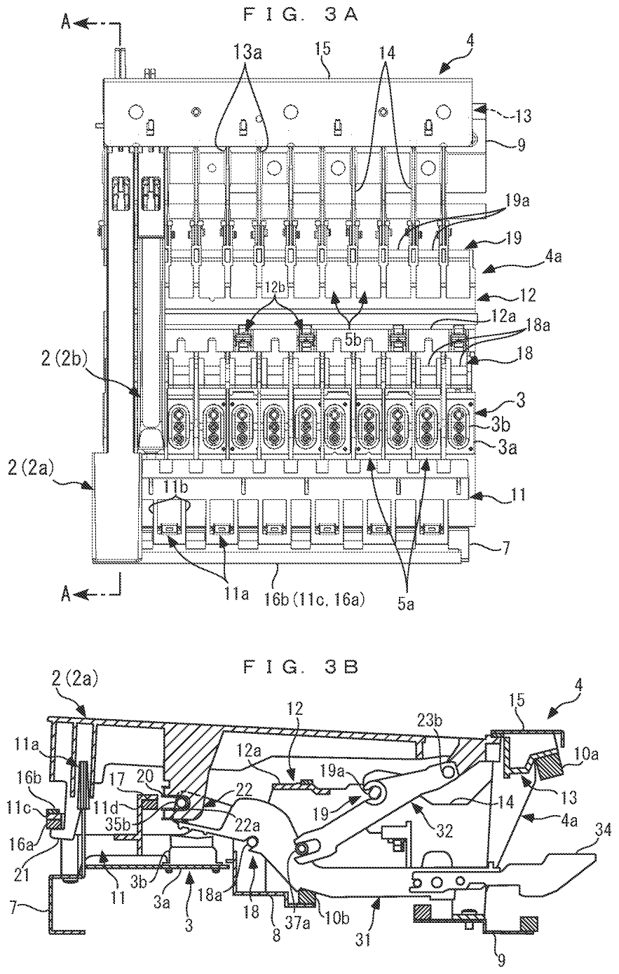

The keyboard chassis 4 includes a chassis body 4a formed as a resin molded article which is made e.g. by injection molding of a predetermined resin material (e.g. an ABS resin) into a predetermined shape. As shown in FIGS. 3A and 3B, the chassis body 4a has a front portion 11, an intermediate portion 12, and a rear portion 13, each extending in the left-right direction (in a left-right direction as viewed in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and 11b, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and that a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, disposed below the chassis intermediate 12.

Further, the above-mentioned key switches 3 are provided on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the above-mentioned first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other so as to be arranged side by side in the left-right direction, and are each screwed to a front rail 7, the middle rail 8, and a rear rail 9 in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

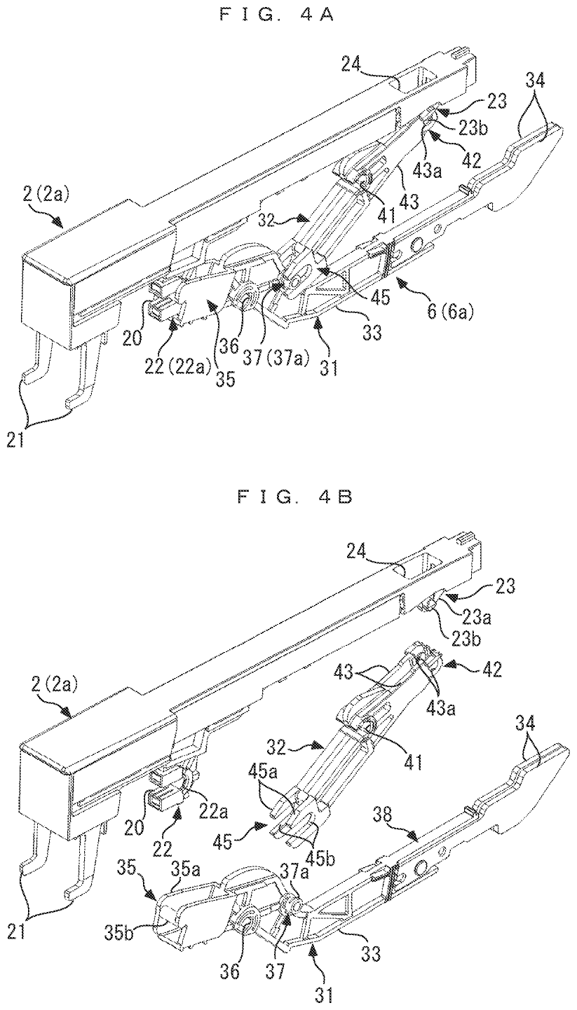

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed e.g. by injection molding of a predetermined resin material (e.g. an AS resin) into a hollow shape which extends a predetermined length in the front-rear direction and opens downward. The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of a front portion of the white key 2a, rearward of the upper limit position regulation portions 21, there is formed a key front-side connecting portion 22 connected to the first arm 31 of the key support mechanism 6a. This key front-side connecting portion 22 includes a connecting recess 22a which has a U shape having a slot-like shape in side view and open forward. Further, the connecting recess 22a has a cushioning member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engagement protrusions 23b and 23b which coaxially protrude from the left and right side surfaces of the connecting body portion 23a, respectively. Further, the rear portion of the white key 2a is formed with a tool insertion hole 24 which vertically extends through the rear portion, and is used to insert a predetermined tool from above for disconnecting the white key 2a from the second arm 32 of the key support mechanism 6a e.g. for maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g. by injection molding of a predetermined resin material (e.g. polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37, which is connected to the second arm 32, at a predetermined location rearward of the bearing portion 36. Specifically, the first arm rear-side connecting portion 37 has a connecting shaft 37a which extends in the left-right direction with respective opposite ends thereof protruding outward from the left and right side surfaces of the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g. by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view at about a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 is formed into a bifurcated shape, and has two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a has an associated one of the engagement protrusions 23b of the key rear-side connecting portion 23 pivotally fitted therein.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

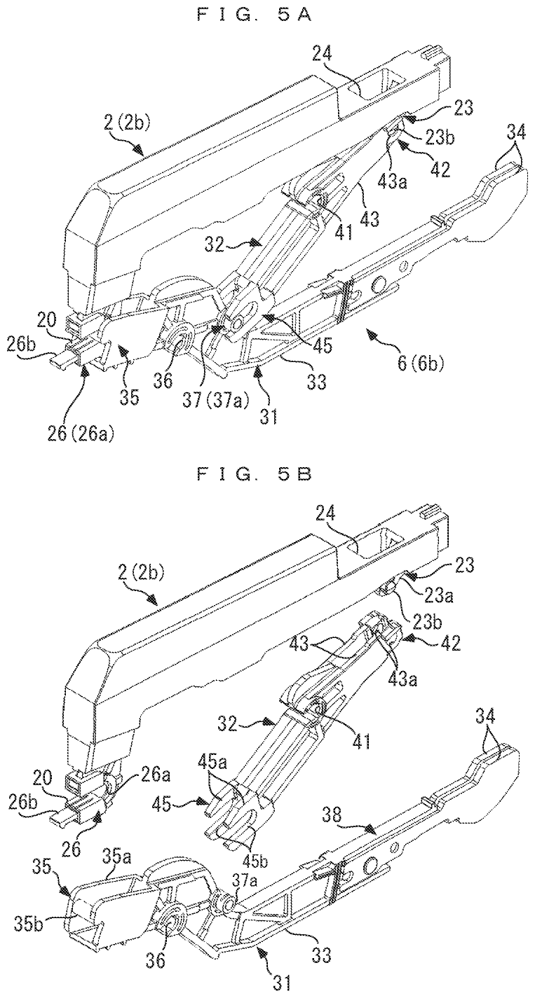

FIG. 5A shows the black key 2b and the key support mechanism 6b therefor on an enlarged scale, and FIG. 5B shows the black key 2b and the key support mechanism 6b in an exploded state. The black key 2b is formed e.g. by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a which has a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that two left and right weights 34 and 34 of the black key-associated key support mechanism 6b differ from the weights 34 of the white key-associated key support mechanism 6a in the shape of the rear portion thereof.

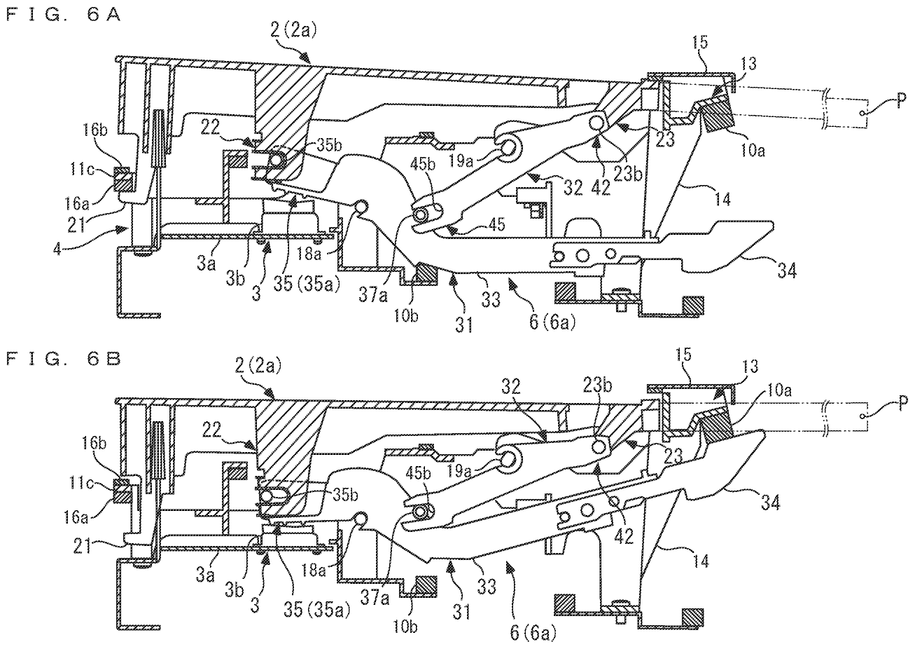

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described hereinabove, in the case where the white key 2a is depressed, in accordance with the counterclockwise pivotal movement of the first arm 31, the weight 34 of the first arm 31 is inclined such that the weight 34 becomes higher as it extends rearward, whereby the rear end of the weight 34 is brought into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as above operates such that it pivotally moves about a virtual pivot P located rearward of the rear end thereof. The location of the virtual pivot P is set such that a distance from the front end of the white key 2a becomes approximately twice as long as the length of the white key 2a itself, for example. With this, when the front end of the white key 2a is depressed to the lowest position, compared with the case where the white key 2a is in the key-released state shown in FIG. 6A, the front end of the white key 2a is positioned lower by a predetermined key stroke (e.g. 10 mm) and the rear end of the white key 2a is located lower by a distance (e.g. 5 mm) which is approximately half of the above key stroke.

On the other hand, when the finger is released from the white key 2a being depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, operation in response to depression of the black key 2b is performed similar to the above-described operations of the white key 2a and the key support mechanism 6a in response to depression of the white key 2a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b operates such that it pivotally moves about a virtual pivot Q located rearward of the rear end thereof. Note that similar to the above-mentioned virtual pivot P of the white key 2a, the location of the virtual pivot Q is set such that a distance from the front end of the black key 2b becomes approximately twice as long as the length of the black key 2b itself, for example. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the above key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

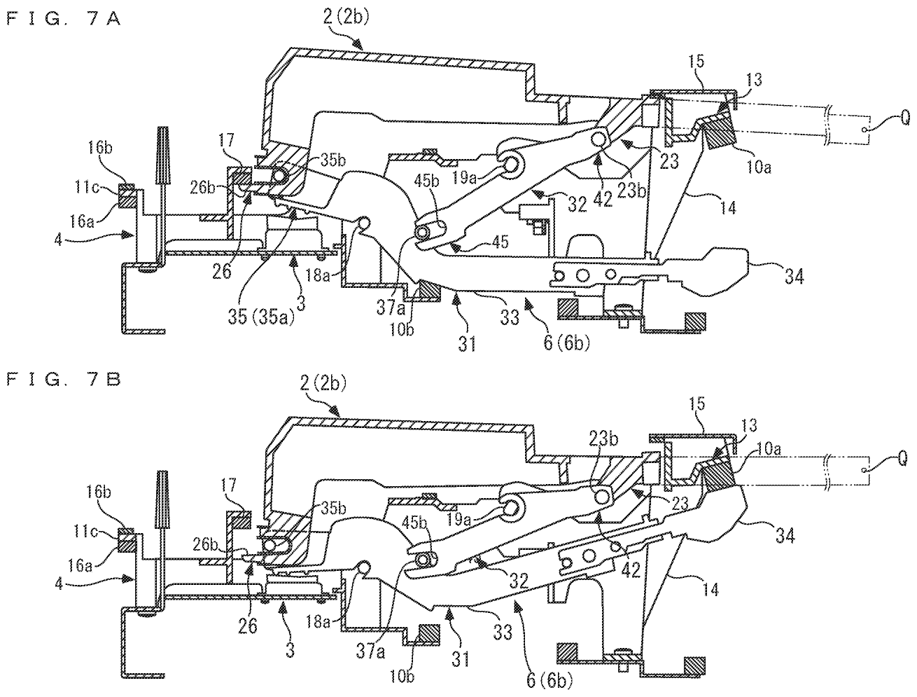

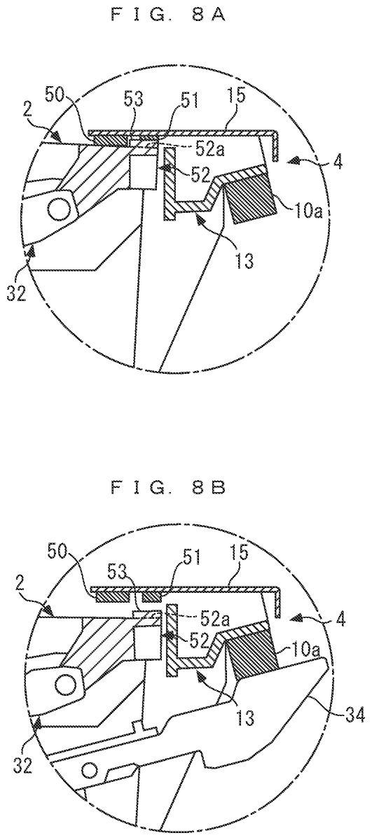

Next, the essential part of the first embodiment of the present invention will be described with reference to FIGS. 8A to 14. The essential part of the first embodiment of the present invention is that a key stopper, with which the rear end of the key 2 moves into contact from below, is provided at the rear end of the keyboard chassis 4, and a protrusion is provided on the upper surface of the rear end of the key 2, and that at least one of the key stopper and the protrusion is arranged in plurality along a longitudinal direction of the key 2.

FIGS. 8A and 8B show the rear end, denoted by reference numeral 52, of the key 2 of the keyboard device 1 according to the first embodiment of the present invention and component parts therearound on an enlarged scale. FIG. 8A shows a key-released state of the key 2 and FIG. 8B shows a key-depressed state of the same. As shown in FIGS. 8A and 8B, two, i.e. front and rear key stoppers 50 and 51 are fixed by bonding to a front end of a lower surface of the above-described cover plate 15. The key stoppers 50 and 51 are made of an elastic material, such as urethane, and are each formed into a block shape which extends in the left-right direction along the entirety of the cover plate 15 and has a predetermined thickness in the vertical direction. Further, out of these key stoppers 50 and 51, the key stopper 51 as the rear key stopper (hereinafter referred to as “the rear-side key stopper 51”) is configured to have a lower resilience than the key stopper 50 as the front key stopper (hereinafter referred to as “the front-side key stopper 50”).

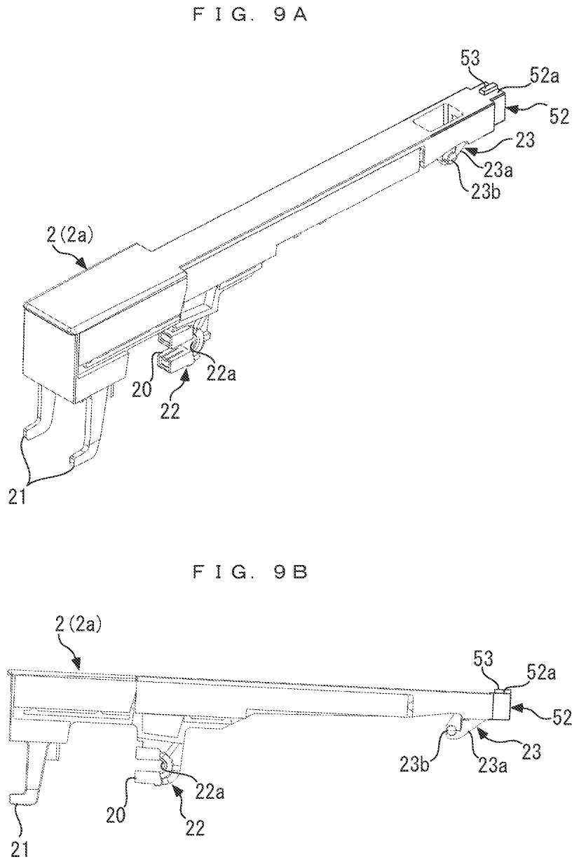

FIGS. 9A and 9B show the appearance of the white key 2a, in which FIG. 9A is a perspective view and FIG. 9B is a right side view. Note that the rear end 52 of the white key 2a and that of the black key 2b are constructed similar to each other, and therefore, the following description is given of the white key 2a regarded as a representative of the keys 2.

As shown in FIGS. 9A and 9B, the rear end 52 of the key 2 has a lateral width shorter than the width of a portion forward thereof. Further, the upper surface of the rear end 52 of the key 2 is integral with the upper surface of the key 2 itself, and forms a contact surface 52a which is in contact with the two key stoppers 50 and 51 from below, in the key-released state. Furthermore, at a rear end of the contact surface 52a of the key 2, there is provided a protrusion 53 which extends along the longitudinal direction of the key 2 and protrudes upward from the contact surface 52a. The upper surface of the protrusion 53 is formed in parallel with the contact surface 52a, and has a smaller area than the contact surface 52a.

Further, in the keyboard device 1, as shown in FIGS. 8A and 8B, the front-side key stopper 50 and the rear-side key stopper 51 are disposed at predetermined front and rear locations (at left and right locations as viewed in FIGS. 8A and 8B) above the chassis rear 13, via the cover plate 15. As shown in FIG. 8A, in the key-released state, the contact surface 52a and the protrusion 53 at the rear end 52 of the key 2 are in contact with the two key stoppers 50 and 51 from below. On the other hand, as shown in FIG. 8B, in the key-depressed state, the rear end 52 of the key 2 moves downward, whereby the contact surface 52a and the protrusion 53 are separated downward from the front-side key stopper 50 and the rear-side key stopper 51.

FIGS. 10A to 10C show a sequence of positions of the rear end 52 of the key 2 as the rear end 52 moves into contact with the two key stoppers 50 and 51 from below when the key 2 depressed is released and returns to its original position where it was before the key depression. FIG. 10A shows a state before the rear end 52 of the key 2 moves into contact with the two key stoppers 50 and 51. When the rear end 52 of the key 2 moves upward, as shown in FIG. 10B, first, the protrusion 53 of the key 2 moves into contact with the rear-side key stopper 51. Then, when the rear end 52 of the key 2 moves further upward, as shown in FIG. 10C, the contact surface 52a of the rear end 52 of the key 2 moves into contact with the front-side key stopper 50 and the rear-side key stopper 51.

As described above, when the rear end 52 of the key 2 moves into contact with the two key stoppers 50 and 51, the protrusion 53 moves into contact with the rear-side key stopper 51 before the contact surface 52a of the key 2 moves into contact with the front-side key stopper 50, whereby it is possible to progressively reduce kinetic energy of the rear end 52 of the key 2, which is rising. With this, it is possible to promptly bring to a standstill the key 2 having returned to its original position where it was before the key depression. Further, since the rear-side key stopper 51 with which the protrusion 53 moves into contact is configured to have a lower resilience than the front-side key stopper 50, it is possible to effectively suppress generation of noise when the protrusion 53 moves into contact with the rear-side key stopper 51.

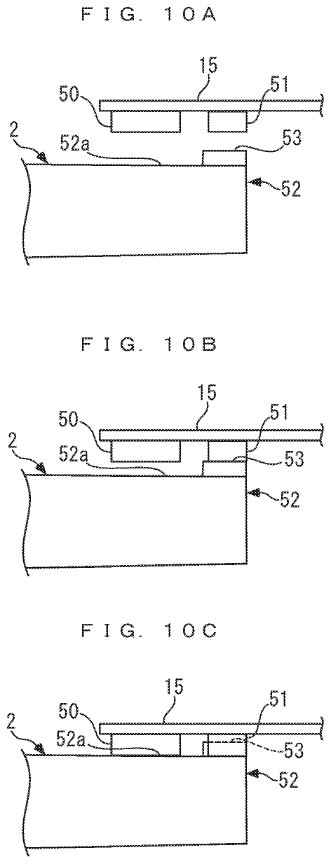

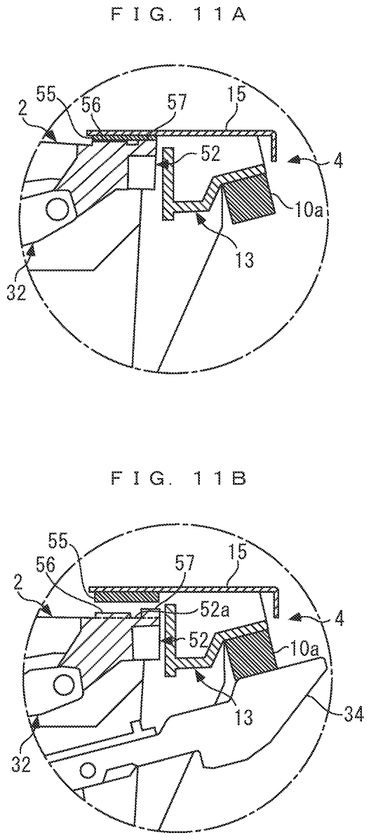

FIGS. 11A and 11B are diagrams showing the rear end 52 of the key 2 of the keyboard device 1 according to a second embodiment of the present invention and component parts therearound on an enlarged scale. FIG. 11A shows a key-released state and FIG. 11B shows a key-depressed state. The present embodiment is different from the first embodiment, described hereinabove, in that a single key stopper 55 is formed on the front end of the lower surface of the cover plate 15, whereas two, i.e. front and rear (left and right, as viewed in FIGS. 11A and 11B) protrusions 56 and 57 are formed on the upper surface of the rear end 52 of the key 2.

Similar to the key stoppers 50 and 51 of the first embodiment, the key stopper 55 is made of an elastic material, such as urethane, and is formed into a block shape which extends in the left-right direction along the entirety of the cover plate 15, and has a predetermined length in the front-rear direction, which is sufficient for the two protrusions 56 and 57 to contact, and a predetermined thickness in the vertical direction.

On the other hand, out of the two protrusions 56 and 57 formed on the upper surface of the rear end 52 of the key 2, the protrusion 57 as the rear protrusion (hereinafter referred to as “the rear-side protrusion 57”) has an upper surface area smaller than that of the protrusion 56 as the front protrusion (hereinafter referred to as “the front-side protrusion 56”), and is formed such that the rear-side protrusion 57 protrudes upward of the front-side protrusion 56.

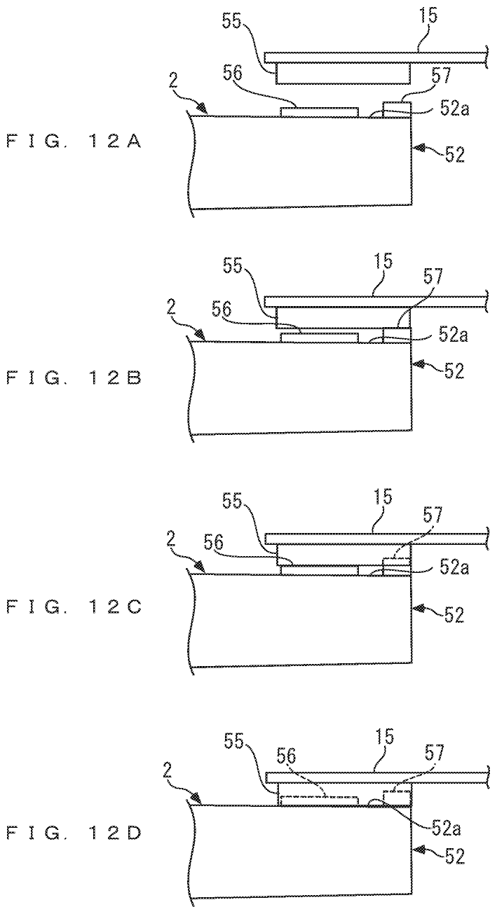

FIGS. 12A to 12D show a sequence of positions of the rear end 52 of the key 2 as the rear end 52 moves into contact with the key stopper 55 from below when the key 2 depressed is released and returns to its original position where it was before the key depression. FIG. 12A shows a state before the rear end 52 of the key 2 moves into contact with the key stopper 55. When the rear end 52 of the key 2 moves upward, as shown in FIG. 12B, first, the rear-side protrusion 57 of the key 2 moves into contact with the key stopper 55. Then, when the rear end 52 of the key 2 moves further upward, as shown in FIG. 12C, the front-side protrusion 56 of the key 2 moves into contact with the key stopper 55. Then, when the rear end 52 of the key 2 moves further upward, as shown in FIG. 12D, the contact surface 52a of the rear end 52 of the key 2 moves into contact with the key stopper 55.

As described above, when the rear end 52 of the key 2 moves into contact with the key stopper 55, the rear-side protrusion 57, which has a small upper surface area, first contacts the key stopper 55, then the front-side protrusion 56 contacts the same, and finally the contact surface 52a contacts the same. With this, while effectively suppressing generation of noise when the rear end 52 of the key 2 moves into contact with the key stopper 55, it is possible to smoothly reduce the kinetic energy of the rising rear end 52 of the key 2, whereby it is possible to promptly bring to a standstill the key 2 having returned to its original position where it was before the key depression.

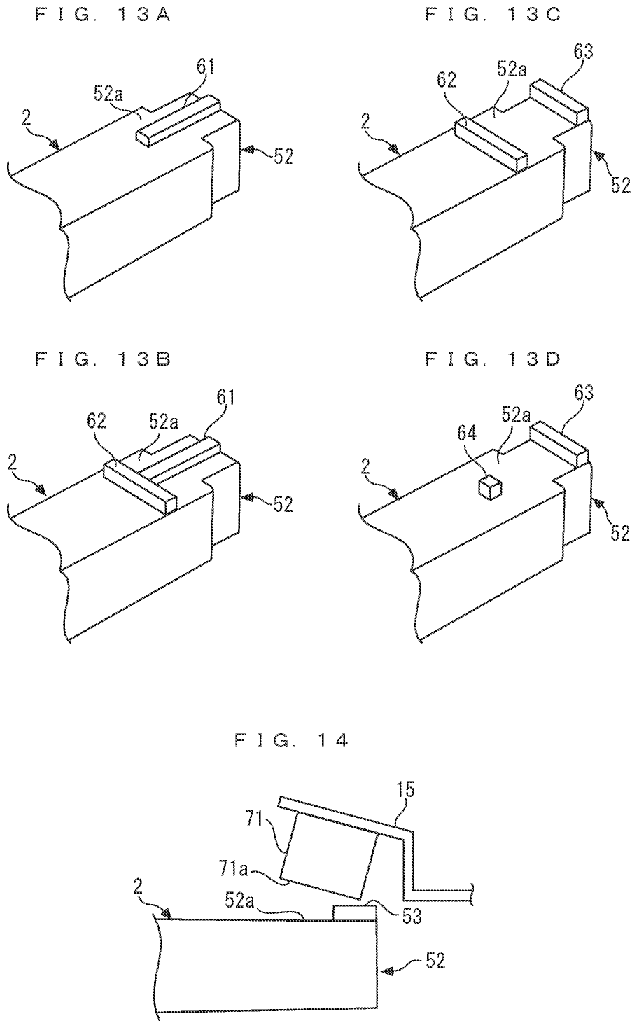

FIGS. 13A to 13D show a variety of variations of the protrusion formed on the upper surface of the rear end 52 of the key 2. A protrusion shown in FIG. 13A is formed by a single protrusion 61 which extends longer in the front-rear direction than the above-described protrusion 53 of the first embodiment. Further, a protrusion shown in FIG. 13B is formed by the above-described protrusion 61 and a protrusion 62 which is formed forward of the protrusion 61 and extends in the left-right direction. Further, a protrusion shown in FIG. 13C is formed by the above-described protrusion 62 and a protrusion 63 which is formed at a rear end of the upper surface of the key 2 and extends in the left-right direction. Furthermore, a protrusion shown in FIG. 13D is formed by the above-described protrusion 63 and a protrusion 64 which is formed forward of the protrusion 63 and has a block shape. As described above, it is possible to employ various protrusions which are formed on the upper surface of the rear end 52 of the key 2.

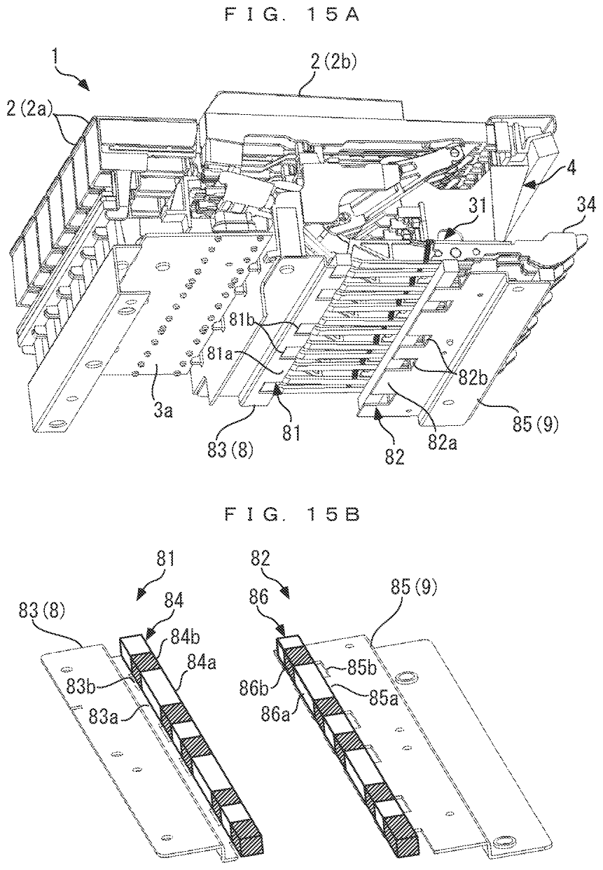

FIG. 14 shows a variation of the above-described key stoppers of the first embodiment. As shown in FIG. 14, this key stopper 71 is set such that a lower surface 71a thereof is inclined forward and upward through a predetermined angle with respect to horizontal. With this, when the rear end 52 of the key 2 contacts the key stopper 71 from below, it is possible to bring the rear end 52 into contact with the key stopper 71 such that the contact area of the rear end 52 is progressively increased, whereby it is possible to suppress generation of noise when the rear end 52 of the key 2 moves into contact with the key stopper 71.

Note that the present invention is not limited to the above-described embodiment, but it can be practiced in various forms. For example, although in the keyboard device 1 of the first embodiment, the two key stoppers 50 and 51 and the single protrusion 53 are provided, whereas in the keyboard device 1 of the second embodiment, the single stopper 55 and the two protrusions 56 and 57 are provided, the present invention is not limited to the above-described embodiments, but it is also possible to provide two or more key stoppers and two or more protrusions. Further, details of the constructions of the keys 2, the key support mechanisms 6, the key stoppers 50, 51, 55, 71, and the protrusions 53, 56 and 57 shown in the embodiments are given only by way of example, and they can be modified as appropriate within the scope of the subject matter of the present invention.

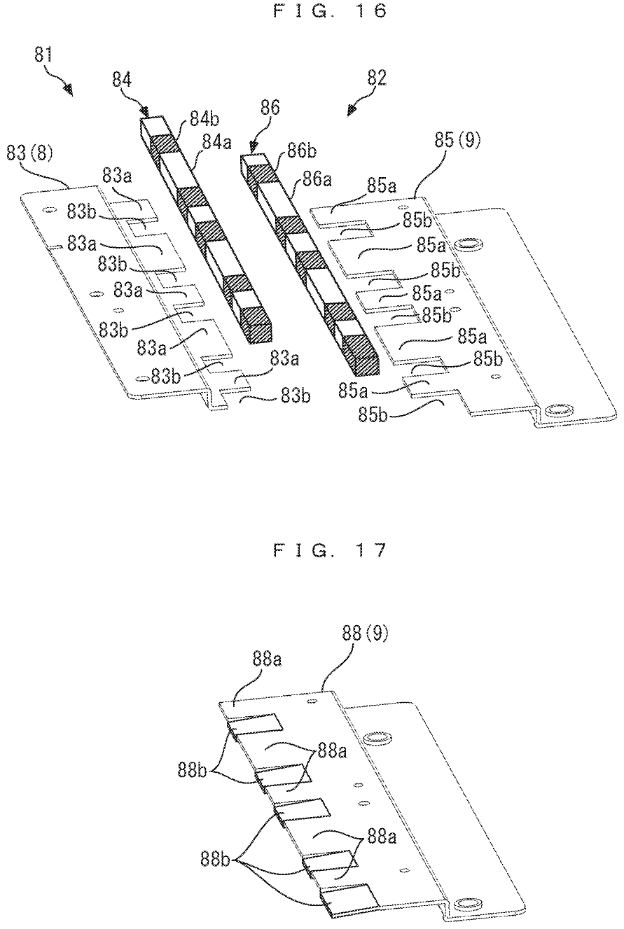

Next, the essential part of the third embodiment of the present invention will be described with reference to FIGS. 15A to 17. The essential part of the third embodiment is that in first arm stoppers 81 and 82, which are provided at the bottom of the keyboard chassis 4 and with which the first arms 31 (hammers) associated with the respective keys move into contact from above, portions of stopper rails 83 and 85, on which cushions 84 and 86 are placed, are configured to be different between ones associated with respective white keys and ones associated with respective black keys.

As shown in FIG. 15A, in the keyboard device 1 of the present invention, the first arm stopper at a forward location (hereinafter referred to as “the front-side stopper”) 81 and the first arm stopper at a rearward location (hereinafter referred to as “the rear-side stopper”) 82 are provided at the bottom of the keyboard chassis 4 with a predetermined spacing therebetween in the front-rear direction. The front-side stopper 81 is comprised of the stopper rail at a forward location (hereinafter referred to as “the front-side stopper rail”) 83 associated with the above-described middle rail 8 and the cushion at a forward location (hereinafter referred to as “the front-side cushion”) 84 formed at a rear end of an upper surface of the front-side stopper rail 83. On the other hand, the rear-side stopper 82 is comprised of the stopper rail at a rearward location (hereinafter referred to as “the rear-side stopper rail”) 85 associated with the above-described rear rail 9 and the cushion at a rearward location(hereinafter referred to as “the rear-side cushion”) 86 formed at a front end of an upper surface of the rear-side stopper rail 85.

FIG. 16 shows the front-side stopper 81 in a state in which the front-side stopper rail 83 and the front-side cushion 84 are separated from each other, and the rear-side stopper 82 in a state in which the rear-side stopper rail 85 and the rear-side cushion 86 are separated from each other. As shown in FIG. 16, each of the front-side stopper rail 83 and the rear-side stopper rail 85 is made e.g. by pressing a metal plate into a predetermined shape, and formed such that each stopper rail extends in the left-right direction (in the direction toward the far side in FIG. 16) as a whole and has a step between a front half and a rear half (a left half and a right half in FIG. 16) thereof.

Further, at a rear end (right end as viewed in FIG. 16) of the front-side stopper rail 83, at a location below the front-side cushion 84, which is contacted from above by the first arms 31 associated with the white keys 2a and the black keys 2b, respectively, a plurality of (five in FIG. 16) white key-associated portions 83a (second key type-associated portions) and a plurality of (five in FIG. 16) black key-associated portions 83b (first key type-associated portions) are alternately formed along the left-right direction of the front-side stopper rail 83. These white key-associated portions 83a are each formed into the shape of a flat plate, and have upper surfaces thereof formed to be flush with each other. On the other hand, the black key-associated portions 83b are each formed into the shape of a cut-out rectangular in plan view and vertically extending through the front-side stopper rail 83.

On the other hand, at a front end (left end as viewed in FIG. 16) of the rear-side stopper rail 85, there are formed a plurality of white key-associated portions 85a (second key type-associated portions) and a plurality of black key-associated portions 85b (first key type-associated portions), which are formed similar to the above-described white key-associated portions 83a and black key-associated portions 83b of the front-side stopper rail 83. More specifically, at the front end of the rear-side stopper rail 85, at a location below the rear-side cushion 86 which is contacted from above by the first arms 31 associated with the white keys 2a and the black keys 2b, respectively, a plurality of (five in FIG. 16) white key-associated portions 85a and a plurality of (five in FIG. 16) black key-associated portions 85b are alternately formed along the left-right direction of the rear-side stopper rail 85. The white key-associated portions 85a are each formed into the shape of a flat plate, whereas the black key-associated portions 85b are each formed into the shape of a rectangular cut-out and vertically extending through the rear-side stopper rail 85.

Each of the front-side cushion 84 and the rear-side cushion 86 is made of an elastic material, such as urethane, extends a predetermined length in the left-right direction, and has a uniform rectangular shape in transverse cross-section over the entire longitudinal length thereof.

The front-side cushion 84 is placed on the rear end of the upper surface of the front-side stopper rail 83 and is mounted on the front-side stopper rail 83 in a state bonded to the white key-associated portions 83a. With this, portions of the front-side cushion 84, associated with the respective white key-associated portions 83a, form white key-associated contact portions 84a with which predetermined front-side portions of respective associated ones of the white key-associated first arms 31 move into contact, and portions of the front-side cushion 84, associated with the respective black key-associated portions 83b, form black key-associated contact portions 84b (hatched portions in FIGS. 15B and 16) with which predetermined front-side portions of respective associated ones of the black key-associated first arms 31 move into contact.

On the other hand, the rear-side cushion 86 is placed at the front end of the upper surface of the rear-side stopper rail 85 and is mounted on the rear-side stopper rail 85 in a state bonded to the white key-associated portions 85a. With this, portions of the rear-side cushion 86, associated with the respective white key-associated portions 85a, form white key-associated contact portions 86a with which predetermined rear-side portions of respective associated ones of the white key-associated first arms 31 move into contact, and portions of the rear-side cushion 86, associated with the respective black key-associated portions 85b, form black key-associated contact portions 86b (hatched portions in FIGS. 15B and 16) with which predetermined rear-side portions of respective associated ones of the black key-associated first arms 31 move into contact.

In the keyboard device 1 including the front-side stopper 81 and the rear-side stopper 82, which are constructed as described above, during manufacturing the keyboard device 1, for example, after the cushions 84 and 86 have been mounted on the stopper rails 83 and 85, the black key-associated contact portions 84b and 86b of the cushions 84 and 86 are formed by being slightly pushed down. With this, upper surfaces of the black key-associated contact portions 84b and 86b of the cushions 84 and 86 are made lower than those of the white key-associated contact portions 84a and 86a. Further, the black key-associated portions 83b and 85b of the stopper rails 83 and 85 are cut out, so that when each black key-associated first arm 31 moves into contact with an associated one of the black key-associated contact portions 84b and 86b of the cushions 84 and 86, the amount of contact is increased.

As described heretofore, according to the present embodiment, by employing a relatively simple construction in which the respective black key-associated portions 83b and 85b of the stopper rails 83 and 85 are cut out, it is possible to adjust heights and amounts of contact of the first arms 31 associated with the black keys 2b which move into contact with the cushions 84 and 86. With this, e.g. by forming the stopper rails 83 and 85 and the cushions 84 and 86 such that they optimally match associated ones of the white key-associated first arms 31, and adjusting the black key-associated contact portions 84b and 86b of the cushions 84 and 86 in the vertical direction, it is possible to obtain excellent touch feeling from both the white keys 2a and the black keys 2b.

FIG. 17 shows a variation of the rear-side stopper rail 85 of the rear-side stopper 82. As shown in FIG. 17, this rear-side stopper rail 88 is different from the above-described rear-side stopper rail 85 only in black key-associated portions 88b. Specifically, the black key-associated portions 85b of the rear-side stopper rail 85 are each cut out vertically through the rear-side stopper rail 85, whereas the black key-associated portions 88b of the rear-side stopper rail 88 according to the variation are each formed to be one step lower in height than the white key-associated portions 88a and inclined forward and downward as the black key-associated portions 88b extend forward (leftward as viewed in FIG. 17). Note that, although omitted from illustration, in the above-described front-side stopper rail 83 as well, similar to the rear-side stopper rail 88, the black key-associated portions 83b may be formed to be one step lower in height than the white key-associated portions 83a and inclined forward and downward as the black key-associated portions 83b extend rearward (rightward as viewed in FIG. 16).

In the rear-side stopper rail 88 including the black key-associated portions 88b formed as above, it is possible not only to obtain the same advantageous effects as obtained by the above-described rear-side stopper rail 85 but also to obtain the following advantageous effects: In the rear-side stopper rail 88, it is possible to relatively easily and stably mount the rear-side cushion 86 on the rear-side cushion 86, by bonding the rear-side cushion 86 not only to upper surfaces of the white key-associated portions 88a but also to upper surfaces of the black key-associated portions 88b. Further, since the upper surfaces of the black key-associated portions 88b of the rear-side stopper rail 88 are formed to be inclined forward and downward as the black key-associated portions 88b extend forward, it is possible to relatively easily and stably work on the black key-associated portions 88b of the rear-side stopper rail 88.

Note that the present invention is not limited to the above-described embodiments, but it can be practiced in various forms. For example, although in the above-described embodiment, in the front-side stopper rail 83 and the rear-side stopper rails 85 and 88, the white key-associated portions 83a and 85a are formed flat, and the black key-associated portions 83b and 85b are each formed into a cut-out shape, or the black key-associated portions 88b of the rear-side stopper rail 88 according to the variation are formed to be lower by a predetermined height, it is also possible to reverse these shapes between the white key-associated portions and the black key-associated portions.

Furthermore, although in the above-described embodiments, the description is given of a case where the present invention is applied to the keyboard device 1 in which the keys 2 depressed operate such that they pivotally move about the virtual pivots P and Q located rearward of the rear ends of the keys 2, respectively, the present invention is not limited to this, but as a matter of course, the present invention can be applied to a general keyboard device in which keys are pivotally moved about the rear ends of their own, respectively, and each of which is not provided with the second arm 32. Further, details of the constructions of the stopper rail 83 and the cushion 84 of the front-side stopper 81, and the stopper rail 85 and the cushion 86 of the rear-side stopper 82 shown in the embodiments are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A keyboard device for a keyboard instrument, comprising:
a keyboard chassis,
a key extending a predetermined length in a front-rear direction and disposed on the keyboard chassis, and
a key support mechanism engaged with the keyboard chassis and provided so as to support the key from below, the key support mechanism causing, upon depression of the key, the depressed key to operate such that the key pivotally moves about a virtual pivot located rearward of a rear end of the key,
wherein the keyboard chassis includes a key stopper with which a rear end of the key moves into contact from below when the key returns to its original position where the key was before the key depression,
wherein the key includes a contact surface which contacts the key stopper, when in a key-released state, and a protrusion formed to protrude upward from the contact surface, and
wherein at least one of the key stopper and the protrusion is disposed in plurality along a longitudinal direction of the key.

2. The keyboard device according to claim 1, wherein the keyboard chassis includes a front-side stopper and a rear-side stopper disposed forward and rearward of each other, as the key stopper,
wherein the key includes one protrusion as the protrusion which contacts one key stopper of the front-side stopper and the rear-side stopper, and
wherein the one key stopper is made of an elastic material having a lower resilience than the other key stopper of the front-side stopper and the rear-side stopper.

3. The keyboard device according to claim 1, wherein the keyboard chassis has one key stopper as the key stopper,
wherein the key includes a front-side protrusion and a rear-side protrusion arranged forward and rearward of each other, as the protrusion, and
wherein one protrusion of the front-side protrusion and the rear-side protrusion is formed such that the one protrusion has an upper surface area smaller than that of the other protrusion of the front-side protrusion and the rear-side protrusion, and protrudes upward of the other protrusion.

4. A keyboard device for a keyboard instrument, comprising:
a keyboard chassis,
a key extending a predetermined length in a front-rear direction and disposed on the keyboard chassis, and
a key support mechanism engaged with the keyboard chassis and provided so as to support the key from below, the key support mechanism causing, upon depression of the key, the depressed key to operate such that the key pivotally moves about a virtual pivot located rearward of a rear end of the key,
wherein the keyboard chassis includes a key stopper with which a rear end of the key moves into contact from below when the key returns to its original position where the key was before the key depression,
wherein the key includes a contact surface for moving into contact with the key stopper in a key-released state, and a protrusion formed to protrude upward from the contact surface, and
wherein the key stopper has a lower surface formed in a state inclined in the front-rear direction.

5. A keyboard device for a keyboard instrument, comprising:
a keyboard chassis;
a plurality of keys each extending in a front-rear direction and arranged side by side in a left-right direction on the keyboard chassis, the plurality of keys being formed by white keys and black keys;
a plurality of hammers extending in the front-rear direction and provided in association with the plurality of keys, respectively, the hammers being pivotally supported, below the keys, on the keyboard chassis, each via a hammer support shaft, and arranged side by side in the left-right direction, for each being vertically pivotally moved in a manner interlocked with depression of an associated one of the keys;
a stopper rail formed into a plate shape extending in the left-right direction and disposed below the keyboard chassis; and
a cushion extending in the left-right direction and having a uniform shape in transverse cross-section over the entire longitudinal length of the cushion, the cushion being mounted in a state placed on the stopper rail and being disposed such that predetermined portions of the plurality of hammers are placed on or opposed to the cushion in a key-released state, the cushion being contacted by the predetermined portions of the hammers from above when the hammers having been pivotally moved upward in accordance with depression of the key return to their original positions after release of the key depressed,
wherein the stopper rail has first key type-associated portions, which are portions below the cushion, for being contacted by associated ones of the hammers associated with a first key type as one of key types of the white keys and the black keys, the first key type-associated portions being formed such that the first key type-associated portions are cut out or lower by a predetermined height with respect to second key type-associated portions, which are portions below the cushion, for being contacted by associated ones of the hammers associated with a second key type as the other of the key types of the white keys and the black keys.

6. The keyboard device according to claim 5, wherein the first key type-associated portions are configured to be lower by the predetermined height than the second key type-associated portions, and in the stopper rail, upper surfaces of the first key type-associated portions being formed such that the upper surfaces are inclined forward and downward as the upper surfaces extend outward in the front-rear direction.

7. The keyboard device according to claim 5, wherein the first key type is a black key, and the second key type is a white key.
